(19) United States
(12) Patent Application Publication
(10) Pub. No.: US 2026/0091340 A1
(43) Pub. Date: Apr. 2, 2026

(54) PROCESSES AND APPARATUSES FOR TREATING A CARBON DIOXIDE STREAM

(71) Applicant: UOP LLC, Des Plaines, IL (US)

(72) Inventors: Nasser Khazeni, Arlington Heights, IL (US); Jayant K. Gorawara, Buffalo Grove, IL (US); Shubhra J. Bhadra, Naperville, IL (US); Kathryn R. Bjorkman Marrou, Mount Prospect, IL (US); Ali Hatami, Katy, TX (US)

(21) Appl. No.: 18/899,923

(22) Filed: Sep. 27, 2024

(51) Int. Cl. B01D 53/04

(52) U.S. Cl. CPC B01D 53/04; B01D 2258/02

(57) ABSTRACT

Processes and apparatuses for removing contaminants from a carbon dioxide stream by passing a concentrated carbon dioxide stream to a treating zone and removing one or more contaminants from the concentrated carbon dioxide stream and provide a treated concentrated carbon dioxide stream, the one or more contaminants selected from a group consisting of: sulfur compounds, heavy hydrocarbons, water, and mixtures thereof, the treating zone comprising at least one vessel containing a solid adsorbent or configured to receive a stream of solvent.

### FIELD OF THE INVENTION

This invention relates generally to processes and apparatuses for treating a carbon dioxide stream, and more particularly to treating a carbon dioxide stream to remove sulfur compounds, water, heavy hydrocarbons.

### BACKGROUND OF THE INVENTION

In order to reduce greenhouse emissions and reduce potential climate change, it desirable to limit the amount of carbon dioxide (CO₂) emitted to the atmosphere. One important technology for emissions abatement is carbon capture, utilization, and storage.

Many chemical processes and plants produce various gaseous streams that contain carbon dioxide. For example, an acid gas removal unit will produce a concentrated carbon dioxide stream by separating a stream of acid gas from, for example, natural gas. However, the concentrated carbon dioxide stream from the acid gas removal unit may also include sulfur compounds such as hydrogen sulfide, and carbonyl sulfide, along with heavy (C6+) hydrocarbons, benzene, toluene, ethyl benzene, xylenes, and water. The presence of these impurities or contaminants in the concentrated carbon dioxide stream limits the processing of the concentrated carbon dioxide stream and has regulatory concerns.

For example, a carbon dioxide stream could be utilized in gaseous form, for enhanced oil recovery, for example. Alternatively, the carbon dioxide stream may be compressed and liquified before being passed to a reservoir or it may be processed in a carbon dioxide fractionation unit.

For either processing, water should be removed. Additionally, heavy (C6+) hydrocarbons, including benzene, toluene, ethyl benzene, xylenes may freeze in the pipeline/liquefaction process and thus, should be removed as well.

Accordingly, it would be desirable to have more effective and efficient ways to process concentrated carbon dioxide streams to provide a treated, concentrated carbon dioxide stream that can take full advantage of carbon capture, utilization, and storage technologies.

### SUMMARY OF THE INVENTION

The present inventors have developed processes for removing, in a treating zone, one or more contaminants from a concentrated carbon dioxide stream. The contaminants include sulfur compounds, heavy hydrocarbons, benzene, toluene, ethyl benzene, xylenes, water, and mixtures thereof. The treating zone may include one or more vessels that include an adsorbent or that receive a solvent. While known processes and materials have been known to remove such contaminants from other streams, such as natural gas streams the present inventors have surprisingly discovered that these technologies and methods may be utilized on a concentrated carbon dioxide stream to effectively and efficiently provide a treated, concentrated carbon dioxide stream that is suitable for various carbon capture, utilization, and storage technologies.

Therefore, the present invention may be characterized, in at least one aspect, as providing a process for treating a carbon dioxide stream by: removing, in a treating zone, one or more contaminants from a concentrated carbon dioxide stream, the one or more contaminants selected from a group consisting of: sulfur compounds, heavy hydrocarbons, water, and mixtures thereof.

The concentrated carbon dioxide stream may be provided from an acid gas process, a membrane separation process, or an oxyfuel process.

The concentrated carbon dioxide stream may comprise at least 50% carbon dioxide and less than 5% methane.

The treating zone may comprise one or more vessels containing a solid adsorbent. The solid adsorbent may be selected from a group consisting of: silica gel, activated alumina, activated carbon, metal oxide, metal carbonate, molecular sieves, and mixtures thereof. The treating zone may comprise two vessels containing a solid adsorbent.

The treating zone may comprise two vessels configured to receive a stream of solvent. The solvent may be selected from a group consisting of: amines, glycol, methanol, cyclic sulfone, alkaline salt solutions, and mixtures thereof. The treating zone may further include one or more vessels containing a solid adsorbent.

In another aspects, the present invention may be broadly characterized as providing a process for treating a carbon dioxide stream by passing a concentrated carbon dioxide stream to a treating zone configured to remove one or more contaminants from the concentrated carbon dioxide stream and provide a treated concentrated carbon dioxide stream, the one or more contaminants selected from a group consisting of: sulfur compounds, heavy hydrocarbons, water, and mixtures thereof.

The concentrated carbon dioxide stream may be passed from an acid gas process, a membrane separation process, or an oxyfuel process.

The concentrated carbon dioxide stream may comprise at least 50% carbon dioxide and less than 5% methane.

The treating zone may comprise one or more vessels containing a solid adsorbent. The solid adsorbent may be selected from a group consisting of: silica gel, activated alumina, metal oxide, metal carbonate, molecular sieves, and mixtures thereof. The treating zone may comprise two vessels containing a solid adsorbent.

The treating zone may comprise one or more vessels configured to receive a stream of solvent. The solvent may be selected from a group consisting of: amines, glycol, methanol, cyclic sulfone, alkaline salt solutions, and mixtures thereof. The treating zone may further comprise one or more vessels containing a solid adsorbent.

In another aspect, the present invention may be characterized, broadly, as providing an apparatus for treating a carbon dioxide stream in which the apparatus comprises: a treating zone configured to receive a concentrated carbon dioxide stream and remove one or more contaminants from the concentrated carbon dioxide stream and provide a treated concentrated carbon dioxide stream. The one or more contaminants are selected from a group consisting of: sulfur compounds, heavy hydrocarbons, water, and mixtures thereof. The treating zone comprises at least one vessel containing a solid adsorbent or configured to receive a stream of solvent. The treating zone comprises one or more vessels configured to receive a stream of solvent.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

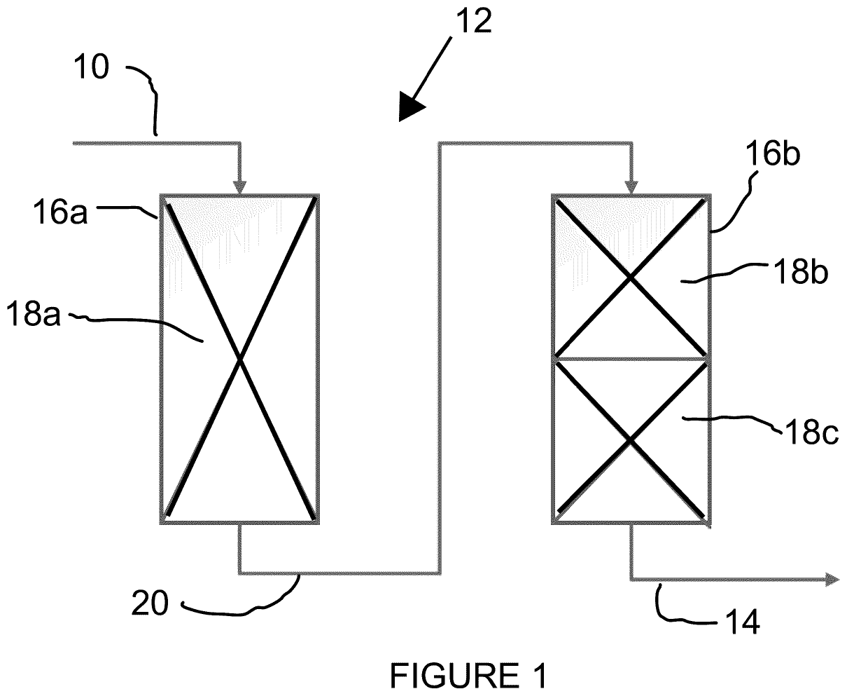

FIG. 1 shows a process flow diagram for a treating zone in a process according to one or more aspects of the present invention;

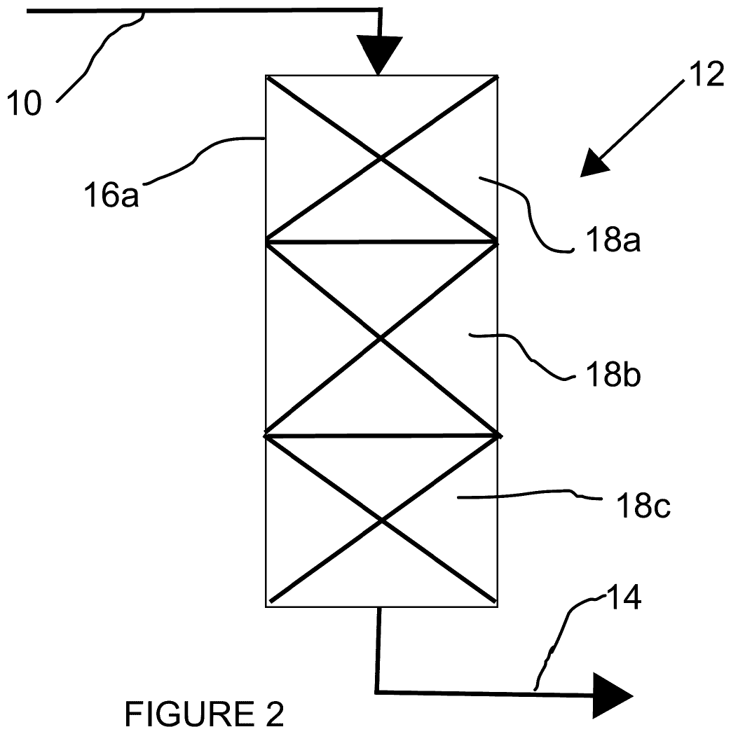

FIG. 2 shows a process flow diagram for a treating zone in a process according to one or more aspects of the present invention; and,

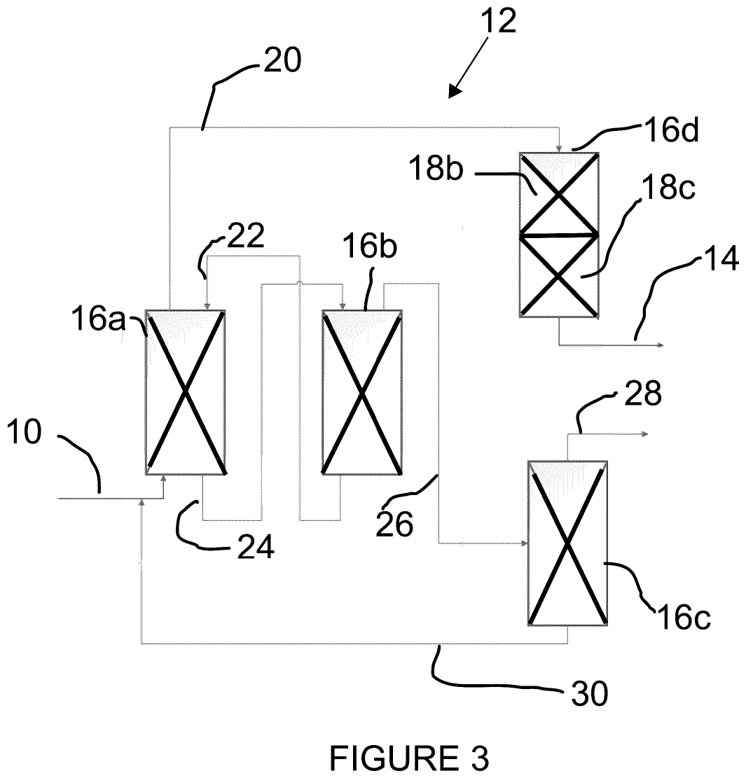

FIG. 3 shows a process flow diagram for a treating zone in a process according to one or more aspects of the present invention.

It should be appreciated and understood by those of ordinary skill in the art that various other components such as valves, pumps, filters, coolers, etc. are not shown in the drawings as it is believed that the specifics of same are well within the knowledge of those of ordinary skill in the art and a description of same is not necessary for practicing or understating the embodiments of the present invention.

### DETAILED DESCRIPTION OF THE INVENTION

As mentioned above, processes and apparatuses for treating a carbon dioxide stream have been invented. The processes and apparatuses utilize a treating zone with one or more vessels that include an adsorbent or that receive a solvent. The adsorbent or solvent separates contaminants include sulfur compounds, heavy hydrocarbons, water, and mixtures thereof from a concentrated carbon dioxide stream to provide a treated, concentrated carbon dioxide stream.

With these general principles in mind, one or more embodiments of the present invention will be described with the understanding that the following description is not intended to be limiting.

Turning to FIGS. 1 to 3, various embodiments of the present invention will be described which are utilized to remove one or more contaminants from a concentrated carbon dioxide stream 10 in a treating zone 12 to provide a treated, concentrated carbon dioxide stream 14. By “treated” it is meant that the treated, concentrated carbon dioxide stream 14 has a lower amount of contaminants compared with the concentrated carbon dioxide stream 10.

The concentrated carbon dioxide stream 10 comprises at least 50% carbon dioxide, or at least 90% carbon dioxide, or at least 95% carbon dioxide. Additionally, the concentrated carbon dioxide stream 10 comprises less than 5% methane. The concentrated carbon dioxide stream 10 may be provided from an acid gas unit. It is also contemplated that concentrated carbon dioxide stream 10 is provided from a membrane separation process or an oxyfuel process. Preferably, the oxygen content of the concentrated carbon dioxide stream 10 is less than 10 ppm.

In the embodiment of FIG. 1, the concentrated carbon dioxide stream 10 is passed to a treating zone 12 that includes two vessels 16a, 16b. The first vessel 16a includes a bed 18a of adsorbent that is configured to selectively adsorb sulfides including hydrogen sulfide and carbonyl sulfides and provide a partially treated stream 20. For example, the solid adsorbent in the first bed 18a may be a nonregenerative solid adsorbent, like a metal carbonate-type adsorbent, e.g., copper carbonate.

The partially treated stream 20 may be passed to the second vessel 16b which has two beds 18b, 18c adsorbent. The first bed 18b in the second vessel 16b comprises a solid adsorbent that is configured to selectively adsorb the majority of water and all heavy hydrocarbons including benzene, toluene, ethyl benzene, and xylenes. By “heavy hydrocarbons,” it is meant that C6+ hydrocarbons including hexane, benzene, toluene, ethyl benzene, and xylenes. For example, the solid adsorbent in the first bed 18b in the second vessel 16b may be a silica gel-type adsorbent. The second bed 18c in the second vessel 16b is configured to selectively adsorb the remaining water. For example, the solid adsorbent in the second bed 18c in the second vessel 16b may be a molecular sieve-type adsorbent. Exemplary adsorbents for heavy hydrocarbons and water are disclosed in, for example, U.S. Pat. No. 8,685,146.

From the second vessel 16, the treating zone 12 provides the treated, concentrated carbon dioxide stream 14 that is suitable for various carbon capture, utilization, processing, and storage technologies. In particular, the treated, concentrated carbon dioxide stream 14 typically comprises less than 1 ppm water, and less than 200 ppm heavy hydrocarbons including less than 20 ppm benzene, toluene, ethyl benzene, xylenes.

Instead of using two vessels 16a, 16b for the beds 18a, 18b, 18c, it is contemplated, as shown in FIG. 2, that the three beds 18a, 18b, 18c of adsorbents are contained in a single vessel 16a. The number of vessels 16a, 16b, 16c, . . . . in the treating zone 12 may vary. In particular, if the solid adsorbents are regenerated using a thermal swing adsorption process, the treating zone 12 may include multiple vessels which are cycled through various stages of adsorption and desorption.

Turning to FIG. 3, the treating zone 12 utilizes a solvent to remove some contaminants. As depicted, the concentrated carbon dioxide stream 10 is passed to a first vessel 16a in the treating zone 12. The first vessel 16a also receives a solvent stream 22 containing a lean solvent that is configured to selective remove the sulfide compounds and some of the carbon dioxide from the remaining components of the concentrated carbon dioxide stream 10. Suitable solvents include amines, glycols, menthols, and mixtures thereof, to name a few. The first vessel 16a provides a rich solvent stream 24 and the partially treated stream 20.

The rich solvent stream 24 comprising solvent, sulfides and some carbon dioxide, is passed to a second vessel 16b, which may be a stripper, which removes the sulfides and carbon dioxide in a stream 26 and provides the solvent stream 22 for the first vessel. The stream 26 with the sulfides and carbon dioxide from the second vessel 16b may be passed to another vessel 16c (or a separate process unit/zone) which converts the sulfides to sulfur 28 and provides a tail gas stream 30 which contains carbon dioxide and which may be recycled back to the first vessel 16a.

The partially treated stream 20 from the first vessel 16a is passed to another vessel 16d that includes two beds 18b, 18c of adsorbents. The adsorbents in these beds 18b, 18c are the same as the ones discussed above in FIG. 1 and are used to remove heavy hydrocarbons including benzene, toluene, ethyl benzene, xylenes and water, respectively. The treating zone 12 again provides the treated, concentrated carbon dioxide stream 14 that is suitable for various carbon capture, utilization, and storage technologies.

### EXPERIMENTS

In an experimental computer simulation, contaminant removal of benzene, toluene and water from a concentrated carbon dioxide stream and a methane feed stream was predicted to be very similar with minimal impact to the product streams meeting specifications.

### SPECIFIC EMBODIMENTS

While the following is described in conjunction with specific embodiments, it will be understood that this description is intended to illustrate and not limit the scope of the preceding description and the appended claims.

A first embodiment of the invention is a process for treating a carbon dioxide stream, the process comprising removing, in a treating zone, one or more contaminants from a concentrated carbon dioxide stream, the one or more contaminants selected from a group consisting of sulfur compounds, heavy hydrocarbons, water, and mixtures thereof. An embodiment of the invention is one, any or all of prior embodiments in this paragraph up through the first embodiment in this paragraph, wherein the concentrated carbon dioxide stream is provided from an acid gas process, a membrane separation process, or an oxyfuel process. An embodiment of the invention is one, any or all of prior embodiments in this paragraph up through the first embodiment in this paragraph, wherein the concentrated carbon dioxide stream comprises at least 50% carbon dioxide and less than 5% methane. An embodiment of the invention is one, any or all of prior embodiments in this paragraph up through the first embodiment in this paragraph, wherein the treating zone comprises one or more vessels containing a solid adsorbent. An embodiment of the invention is one, any or all of prior embodiments in this paragraph up through the first embodiment in this paragraph, wherein the solid adsorbent is selected from a group consisting of silica gel, activated alumina, activated carbon, metal oxide, metal carbonate, molecular sieves, and mixtures thereof. An embodiment of the invention is one, any or all of prior embodiments in this paragraph up through the first embodiment in this paragraph, wherein the treating zone comprises two vessels containing a solid adsorbent. An embodiment of the invention is one, any or all of prior embodiments in this paragraph up through the first embodiment in this paragraph, wherein the treating zone comprises two vessels configured to receive a stream of solvent. An embodiment of the invention is one, any or all of prior embodiments in this paragraph up through the first embodiment in this paragraph, wherein the solvent is selected from a group consisting of amines, glycol, methanol, cyclic sulfone, alkaline salt solutions, and mixtures thereof. An embodiment of the invention is one, any or all of prior embodiments in this paragraph up through the first embodiment in this paragraph, wherein the treating zone comprises one or more vessels containing a solid adsorbent.

A second embodiment of the invention is a process for treating a carbon dioxide stream, the process comprising passing a concentrated carbon dioxide stream to a treating zone configured to remove one or more contaminants from the concentrated carbon dioxide stream and provide a treated concentrated carbon dioxide stream, the one or more contaminants selected from a group consisting of sulfur compounds, heavy hydrocarbons, water, and mixtures thereof. An embodiment of the invention is one, any or all of prior embodiments in this paragraph up through the second embodiment in this paragraph, wherein the concentrated carbon dioxide stream is passed from an acid gas process, a membrane separation process, or an oxyfuel process. An embodiment of the invention is one, any or all of prior embodiments in this paragraph up through the second embodiment in this paragraph, wherein the concentrated carbon dioxide stream comprises at least 50% carbon dioxide and less than 5% methane. An embodiment of the invention is one, any or all of prior embodiments in this paragraph up through the second embodiment in this paragraph, wherein the treating zone comprises one or more vessels containing a solid adsorbent. An embodiment of the invention is one, any or all of prior embodiments in this paragraph up through the second embodiment in this paragraph, wherein the solid adsorbent is selected from a group consisting of silica gel, activated alumina, metal oxide, metal carbonate, molecular sieves, and mixtures thereof. An embodiment of the invention is one, any or all of prior embodiments in this paragraph up through the second embodiment in this paragraph, wherein the treating zone comprises two vessels containing a solid adsorbent. An embodiment of the invention is one, any or all of prior embodiments in this paragraph up through the second embodiment in this paragraph, wherein the treating zone comprises one or more vessels configured to receive a stream of solvent. An embodiment of the invention is one, any or all of prior embodiments in this paragraph up through the second embodiment in this paragraph, wherein the solvent is selected from a group consisting of amines, glycol, methanol, cyclic sulfone, alkaline salt solutions, and mixtures thereof. An embodiment of the invention is one, any or all of prior embodiments in this paragraph up through the second embodiment in this paragraph, wherein the treating zone comprises one or more vessels containing a solid adsorbent.

A third embodiment of the invention is an apparatus for treating a carbon dioxide stream, the apparatus comprising a treating zone configured to receive a concentrated carbon dioxide stream and remove one or more contaminants from the concentrated carbon dioxide stream and provide a treated concentrated carbon dioxide stream, the one or more contaminants selected from a group consisting of sulfur compounds, heavy hydrocarbons, water, and mixtures thereof, the treating zone comprising at least one vessel containing a solid adsorbent or configured to receive a stream of solvent. An embodiment of the invention is one, any or all of prior embodiments in this paragraph up through the third embodiment in this paragraph, wherein the treating zone further comprises one or more vessels configured to receive a stream of solvent.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process for treating a carbon dioxide stream, the process comprising:
removing, in a treating zone, one or more contaminants from a concentrated carbon dioxide stream, the one or more contaminants selected from a group consisting of: sulfur compounds, heavy hydrocarbons, water, and mixtures thereof.

2. The process of claim 1, wherein the concentrated carbon dioxide stream is provided from an acid gas process, a membrane separation process, or an oxyfuel process.

3. The process of claim 1, wherein the concentrated carbon dioxide stream comprises at least 50% carbon dioxide and less than 5% methane.

4. The process of claim 1, wherein the treating zone comprises one or more vessels containing a solid adsorbent.

5. The process of claim 4, wherein the solid adsorbent is selected from a group consisting of: silica gel, activated alumina, activated carbon, metal oxide, metal carbonate, molecular sieves, and mixtures thereof.

6. The process of claim 4, wherein the treating zone comprises two vessels containing a solid adsorbent.

7. The process of claim 1, wherein the treating zone comprises two vessels configured to receive a stream of solvent.

8. The process of claim 7, wherein the solvent is selected from a group consisting of: amines, glycol, methanol, cyclic sulfone, alkaline salt solutions, and mixtures thereof.

9. The process of claim 7, wherein the treating zone comprises one or more vessels containing a solid adsorbent.

10. A process for treating a carbon dioxide stream, the process comprising:
passing a concentrated carbon dioxide stream to a treating zone configured to remove one or more contaminants from the concentrated carbon dioxide stream and provide a treated concentrated carbon dioxide stream, the one or more contaminants selected from a group consisting of: sulfur compounds, heavy hydrocarbons, water, and mixtures thereof.

11. The process of claim 10, wherein the concentrated carbon dioxide stream is passed from an acid gas process, a membrane separation process, or an oxyfuel process.

12. The process of claim 10, wherein the concentrated carbon dioxide stream comprises at least 50% carbon dioxide and less than 5% methane.

13. The process of claim 10, wherein the treating zone comprises one or more vessels containing a solid adsorbent.

14. The process of claim 13, wherein the solid adsorbent is selected from a group consisting of: silica gel, activated alumina, metal oxide, metal carbonate, molecular sieves, and mixtures thereof.

15. The process of claim 13, wherein the treating zone comprises two vessels containing a solid adsorbent.

16. The process of claim 10, wherein the treating zone comprises one or more vessels configured to receive a stream of solvent.

17. The process of claim 16, wherein the solvent is selected from a group consisting of: amines, glycol, methanol, cyclic sulfone, alkaline salt solutions, and mixtures thereof.

18. The process of claim 16, wherein the treating zone comprises one or more vessels containing a solid adsorbent.

19. An apparatus for treating a carbon dioxide stream, the apparatus comprising:
a treating zone configured to receive a concentrated carbon dioxide stream and remove one or more contaminants from the concentrated carbon dioxide stream and provide a treated concentrated carbon dioxide stream, the one or more contaminants selected from a group consisting of: sulfur compounds, heavy hydrocarbons, water, and mixtures thereof, the treating zone comprising at least one vessel containing a solid adsorbent or configured to receive a stream of solvent.

20. The apparatus of claim 19, wherein the treating zone further comprises one or more vessels configured to receive a stream of solvent.
